(19) United States
(12) Patent Application Publication
(10) Pub. No.: US 2013/0178770 A1
(43) Pub. Date: Jul. 11, 2013

(54) MASSAGE APPARATUS FOR JETTED SPAS

(71) Applicant: SPARTNER ACCESSORIES INC., Calgary (CA)

(72) Inventors: Jean-Pierre JUTRAS, Calgary (CA); Julianna BARABAS, Calgary (CA)

(73) Assignee: SPARTNER ACCESSORIES INC., Calgary (CA)

(21) Appl. No.: 13/723,786

(22) Filed: Dec. 21, 2012

Related U.S. Application Data
(60) Provisional application No. 61/583,983, filed on Jan. 6, 2012.

(51) Int. Cl. A61H 33/00

(52) U.S. Cl. CPC A61H 33/00
USPC 601/160

(57) ABSTRACT

A massage apparatus is provided for use in water environments in vessels such as jetted spas, baths, hot tubs and the like, the apparatus having a massager including rotatable, imbalanced impeller. An inlet of the massager is fluidly connected to a jet and an outlet is directed back to the water environment below the waterline. Flexible inlet and outlet conduits enable versatile positioning of the massager. The inlet conduit is connected via an adapter such as a funnel to a vessel wall or by a union to an individual jet.

### FIELD

The present disclosure relates to a massage apparatus, and more particularly to a hand-held massager with a fluid intake adapter for connection to fluid outlets from jetted spas, baths, hot tubs and the like.

### BACKGROUND

Jetted water vessels such as spas, baths and hot tubs are commonly used to provide a user with a soothing hydro massage for athletic, recreational and therapeutic applications. The hydro massage is provided by jets placed at various locations in the vessels which discharge a mix of water and air. These jets are typically positioned below the waterline in order to create a massaging turbulence within the vessel. In shallower vessels, such as spas and hot tubs, if the waterline is around a user's chest or torso, then massage of the neck and shoulders becomes difficult. Furthermore, the fixed position of the jets at pre-determined various points in the walls of the vessels makes it difficult to focus the hydro massage on other areas of the body that are not easily positionable in front of one or more jets.

Handheld hydro massage heads which discharge a jet of water are known, but if they are lifted above the waterline, they can cause significant splashing and disturbance not only for the user but also for other users sharing the vessel. Thus, what is needed is an improved massage unit for vessels, such as jetted spas, baths and hot tubs, which overcomes at least some of the drawbacks and limitations as described above.

### SUMMARY

The present disclosure relates to a massage apparatus. Generally, forms of adapter are provided for securely and simply receiving massager-energizing fluids from fluid outlets associated with open water containment vessels for user's recreation and therapeutic purposes such as jetted spas, baths, hot tubs and the like. The vessels contain water and establish a waterline for partially immersing a user. The fluid outlets or jets are typically located below the waterline. In embodiments of the massage apparatus, components can be lifted above the waterline without an incurring splashing and are easily adapted to interface with various sources and fluid outlets of energizing fluid. Embodiments disclosed herein overcome at least some of the limitations of prior massaging devices by providing a massaging action that is minimally intrusive to the user and others sharing the vessel without the need for mechanical revisions or modifications to existing fluid sources or jets as are typically provided pre-installed by the vessel manufacturers.

Herein, the massager, forms of fluid outlet adapters, assemblages thereof and methods for implementing the massager are described in the context of a jetted spa vessel although any vessel such as jetted spas, baths, hot tubs and the like are contemplated as characterized by either an energizing fluid source supported or otherwise emanating from a vessel wall. Further, or alternatively, the energizing fluid source is a fluid conduit such as a jet or faucet discharge associated, or not, with such as vessel. An embodiment of the adapter is equally versatile for fluid-tight connection to a jet nozzle or a faucet discharge. The energizing source is typically water, or a mixture of water and air, air often being comingled with the flow of water for varying the characteristics of the fluid from the jets.

In an embodiment, the massage apparatus includes a hand-held massage unit or massager having an impeller chamber that houses a rotatable, off-set weighted impeller. The massager has a fluid inlet connected to a source of energizing fluid. A fluid outlet from the massager is directed for discharge into a fluid reservoir such as below the waterline in a spa. The inlet of the impeller chamber is connected to the energizing fluid source with an inlet conduit. The outlet is fit with a discharge conduit which can be located by the user, such as below the waterline. The conduit is fit to energizing fluid source with an adapter. In one embodiment, the adapter is an intake funnel that can be fit to the wall of the spa about the fluid source. In another embodiment, a nozzle adapter is fit directly to a jet nozzle.

The apparatus enables effective connection to the energizing fluid source and, in operation, minimizes splashing previously related to fluid discharge. The intake funnel or nozzle adapter receives a jet of fluid, typically a mixture of water/air, from the spa, bath or hot tub, which is then directed through the tube and into the impeller chamber. Within the impeller chamber, the jet contacts the blades of the weighted impeller and causes the impeller to rotate rapidly, at speeds that can vary according to the fluid flow including and amount and pressure provided by the jets. The impeller chamber is shaped and adapted such that the jet of water entering the impeller chamber quickly exits the chamber via the outlet. In an embodiment, the outlet is larger than the inlet to avoid restricting the fluid flow from the impeller chamber and hindering rotation of the impeller. The fluid exits the impeller chamber via the outlet which is connected to via the outlet conduit for discharging back into the vessel beneath the waterline.

In one method, a massager is operated in a water containment vessel having at least one jet by providing a fluid-operated massager, fluidly connecting an inlet of the massager to one jet of the at least one jet for energizing the massager; and directing fluid from the massager for discharge beneath a waterline of the vessel. The massager is fluidly connected to the one jet by connecting one end of an inlet conduit to the massager inlet and an opposing end to a jet adapter, such as a funnel about the jet or union to the jet; and securing the adapter for receiving the fluid from the one jet.

While described in the context of a spa, the present disclosure is not limited to the specific details of construction and to the arrangements of the components set forth in the following description or illustrated in the drawings. The present invention is capable of other embodiments and of being practiced and carried out in various alternate embodiments. Also, it is to be understood that the phraseology and terminology employed herein are for the purpose of description and should not be regarded as limiting.

### BRIEF DESCRIPTION OF THE DRAWINGS

FIGS. 1A and 1B are perspective and plan views respectively of an embodiment of a massage apparatus having one embodiment of an adapter for coupling the inlet to a jet and a having a submerged outlet discharging below the waterline;

FIG. 2 is an exploded perspective view of a massager in accordance with one embodiment;

FIGS. 3A, 3B and 3C are perspective, top and side views respectively, the housing being partially transparent for illustrating the internals thereof;

FIGS. 4A, 4B and 4C are top, side and underside views of a top shell of the massager of FIG. 3A;

FIGS. 5A, 5B and 5C are top, side and underside views of a bottom shell of the massager of FIG. 3A, corresponding to the top shell of FIGS. 4A-4C;

FIGS. 6A and 6B are side and underside views respectively of a detachable massage membrane, replaceable for different massage configurations;

FIGS. 7A, 7B and 7C are perspective, top and side views respectively of the impeller for the massager of FIG. 3A;

FIG. 8A is a perspective view of a massager assembly comprising a massager, inlet and outlet conduits and one embodiment of a jet fluid adapter;

FIGS. 8B and 8C are top and side views respectively of the massager assembly of FIG. 8A, the funnel being partially cut-away to show the fluid from the jet;

FIG. 8D is a clip for releaseably retaining the inlet and outlet conduits together;

FIGS. 9A, 9B, 9C and 9D are perspective, outside end, side and inside views of the funnel type adapter of the embodiment of FIG. 8A;

FIGS. 10A through 10D are perspective, side, plan and end views of a suction cup clip assembly for the funnel assembly of FIGS. 8A-9D;

FIG. 11 is a side, cross-sectional view of a second embodiment of a jet adapter fit to an eyeball jet in the wall of a jetted spa according to the assembly of FIGS. 1A and 1B;

FIG. 12 is a side perspective view of the adapter of FIG. 11;

FIG. 13A is a first, side, cross-sectional view of the adapter of FIG. 11;

FIG. 13B is a second, side, cross-sectional view of the adapter of FIG. 11;

FIG. 13C is a top view of the adapters of FIG. 13B;

FIGS. 14A and 14B are end and side views respectively of a compression ring suitable for securing the intake conduit to the adapter or the adapter to the jet, the size of which is determined by the adapter location;

FIG. 15A is an exploded perspective view of the union adapter of FIG. 11 before being fit to a jet nozzle; and

FIGS. 15B and 15C are sized annular compression rings, a smaller ring for securing the intake conduit to the adapter and a larger ring for securing the adapter to the jet respectively.

### DETAILED DESCRIPTION

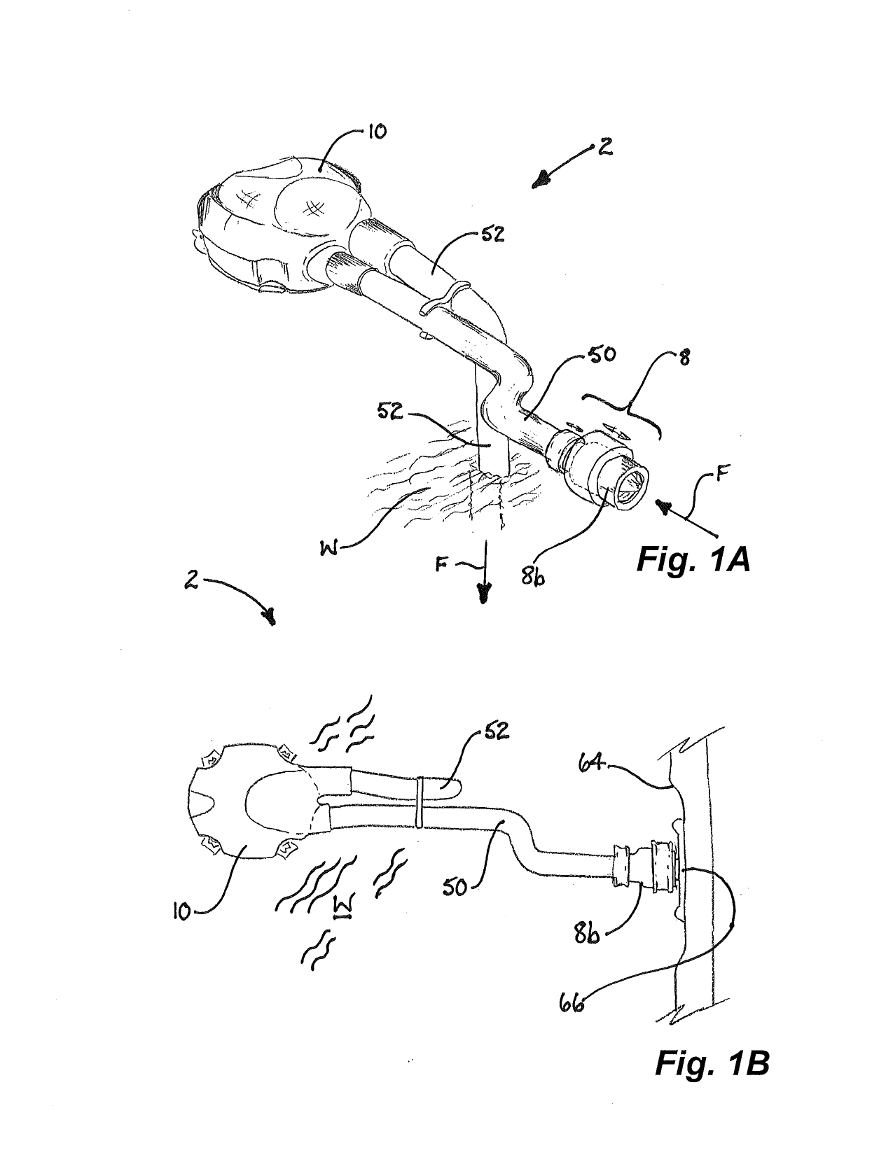

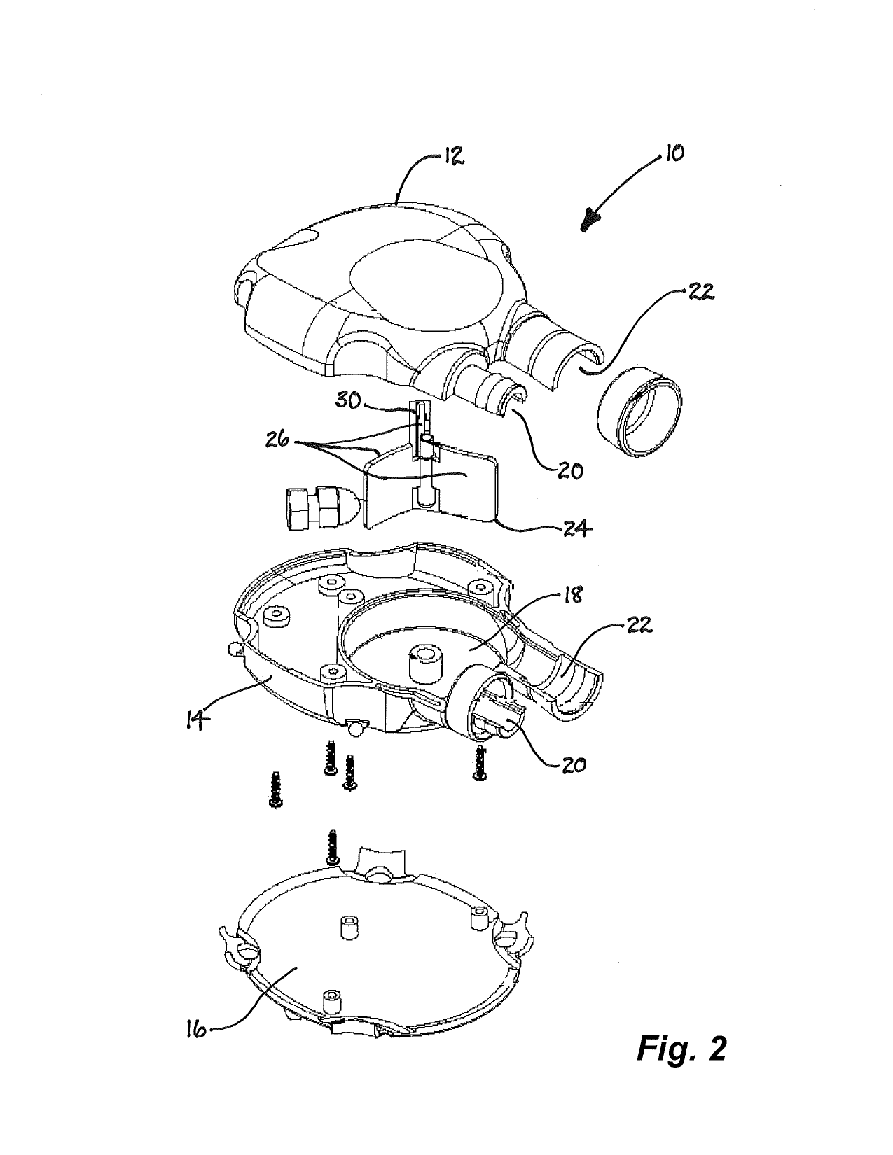

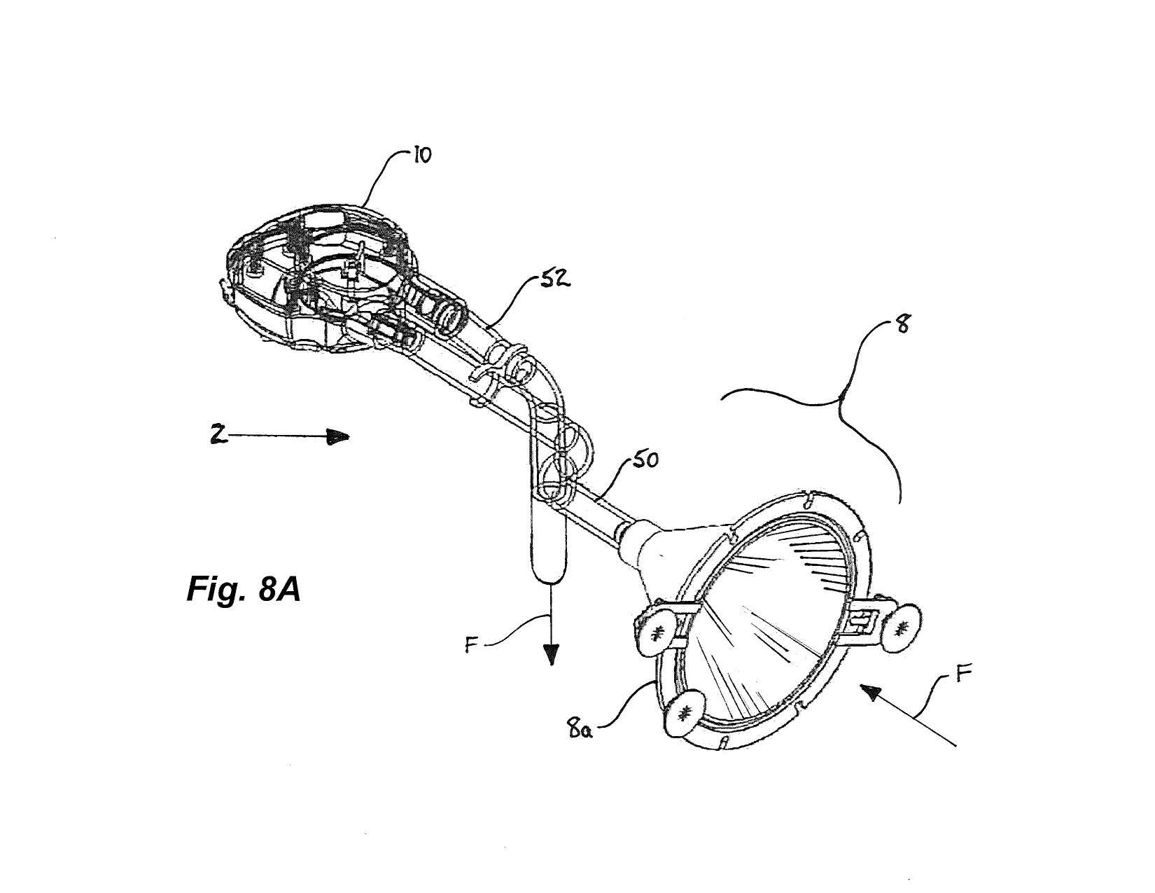

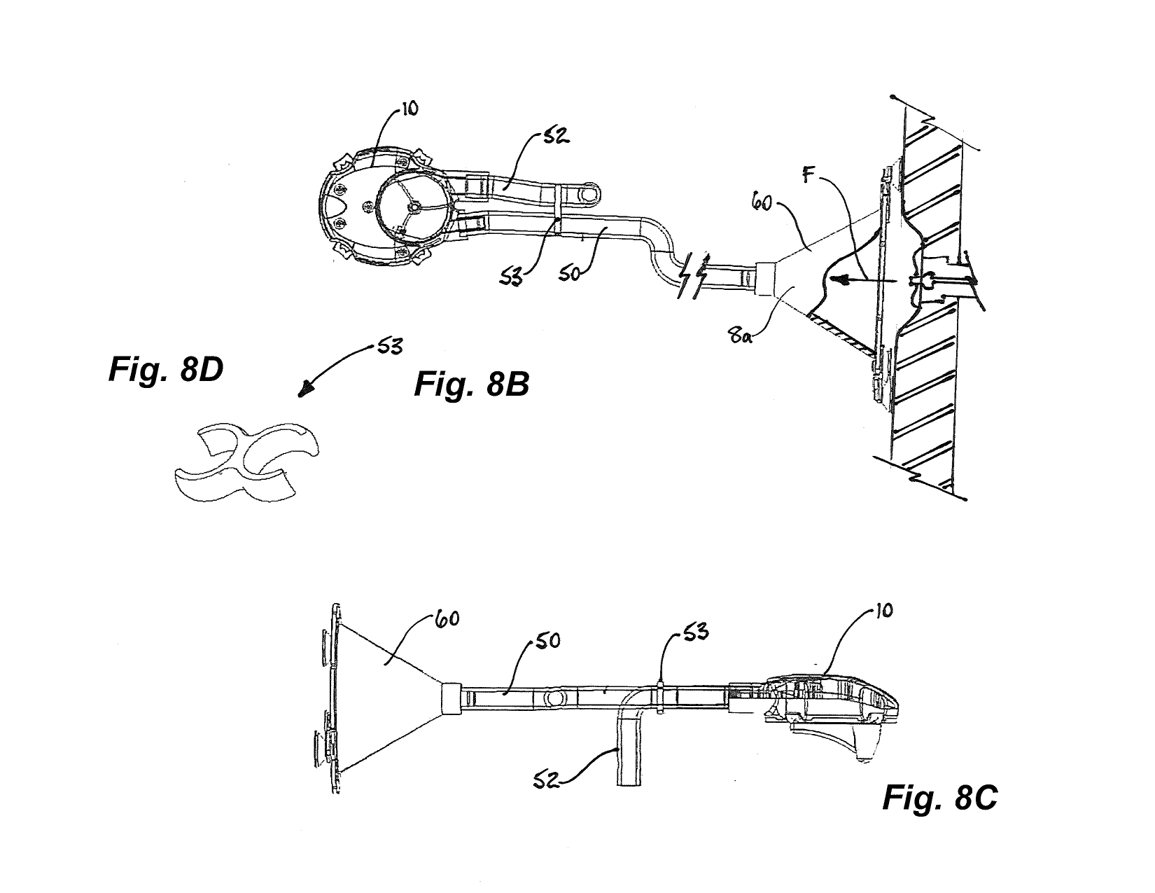

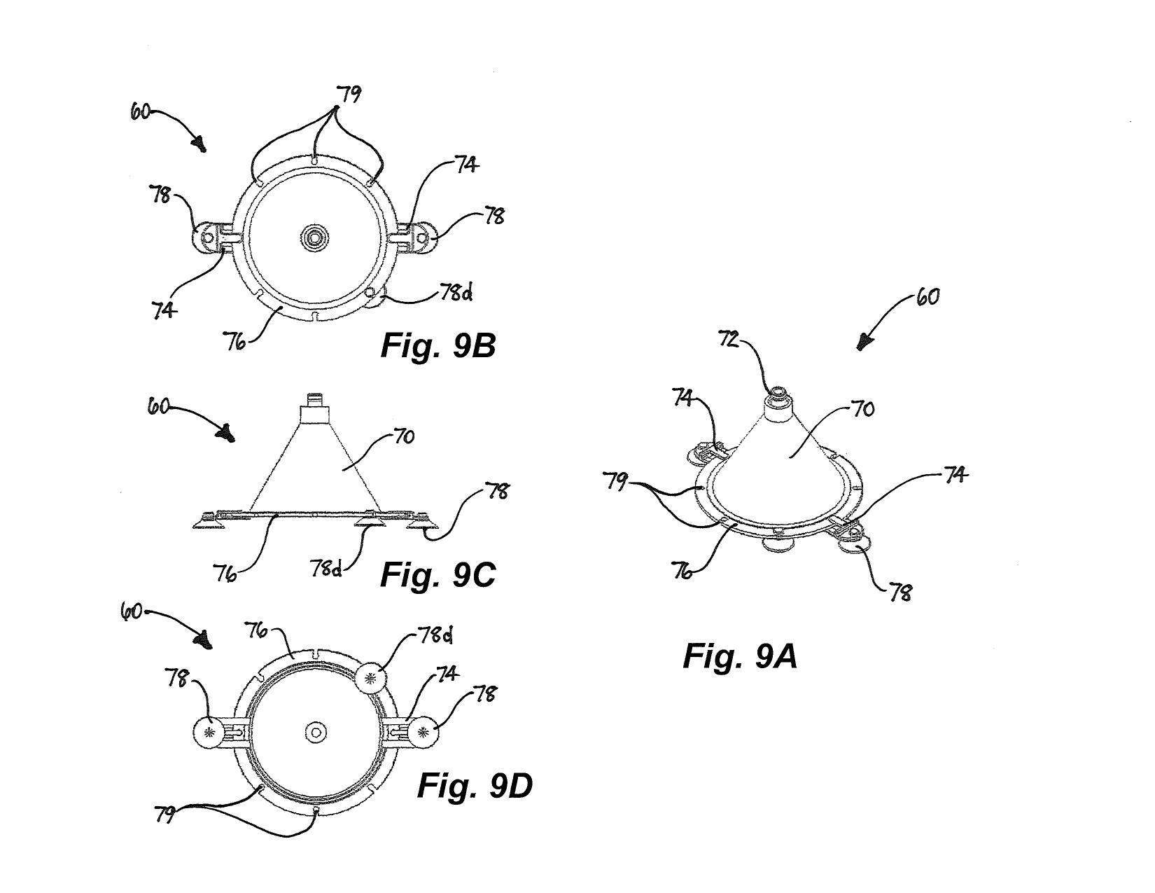

With reference to FIGS. 1A and 1B, a massager assembly 2 is provided. As shown in FIG. 1B, the massager assembly 2 receives fluid from a jet for energizing a massager 10. A massager 10 is provided, the massager 10 and its components being shown in FIGS. 2 through 6B. The massager 10 utilizes an off-set or off-center, weighted or otherwise imbalanced impeller as shown in FIGS. 2A through 2C. The impeller is energized using a flow of energizing fluid flowing in through an inlet conduit and out through an outlet conduit connected to the massager 10 as shown in FIGS. 1A, 1B and FIGS. 8A through 8C. The fluid from a jet is directed into the inlet conduit using an adapter 8, a first embodiment or first adapter 8a being shown in FIGS. 8A through 9D. A second embodiment or adapter 8b is shown in FIGS. 1A, 1B and FIG. 11 through 15C.

In more detail and turning to FIG. 2, an embodiment of a massage unit or massager 10 comprises a top shell 12, a bottom shell 14 and replaceable membrane 16. The top and bottom shells 12,14 are clamshell assembled together for forming an impeller chamber 18 within. The impeller chamber 18 is provided with a fluid inlet 20 and a fluid outlet 22.

The top shell 12 generally forms an outer and inner structure of a top of a sectional massager 10. The bottom shell 14 is a corresponding component forming an outer and inner structure of a bottom of the massager 10. The top and bottom shells 12,14 correspond for forming fluid flow paths for energizing an impeller 24. The membrane 16 can be removably and replaceably attached to and extends from the bottom shell 14. The membrane can be integrated with the bottom shell 14 however more versatility is achieved using replaceable components. The membrane provides various points of user contact for massaging purposes. The impeller chamber 18 houses the impeller 24 which spins when fluid enters the chamber 18 via inlet 20, energizing the impeller, and exits via outlet 22.

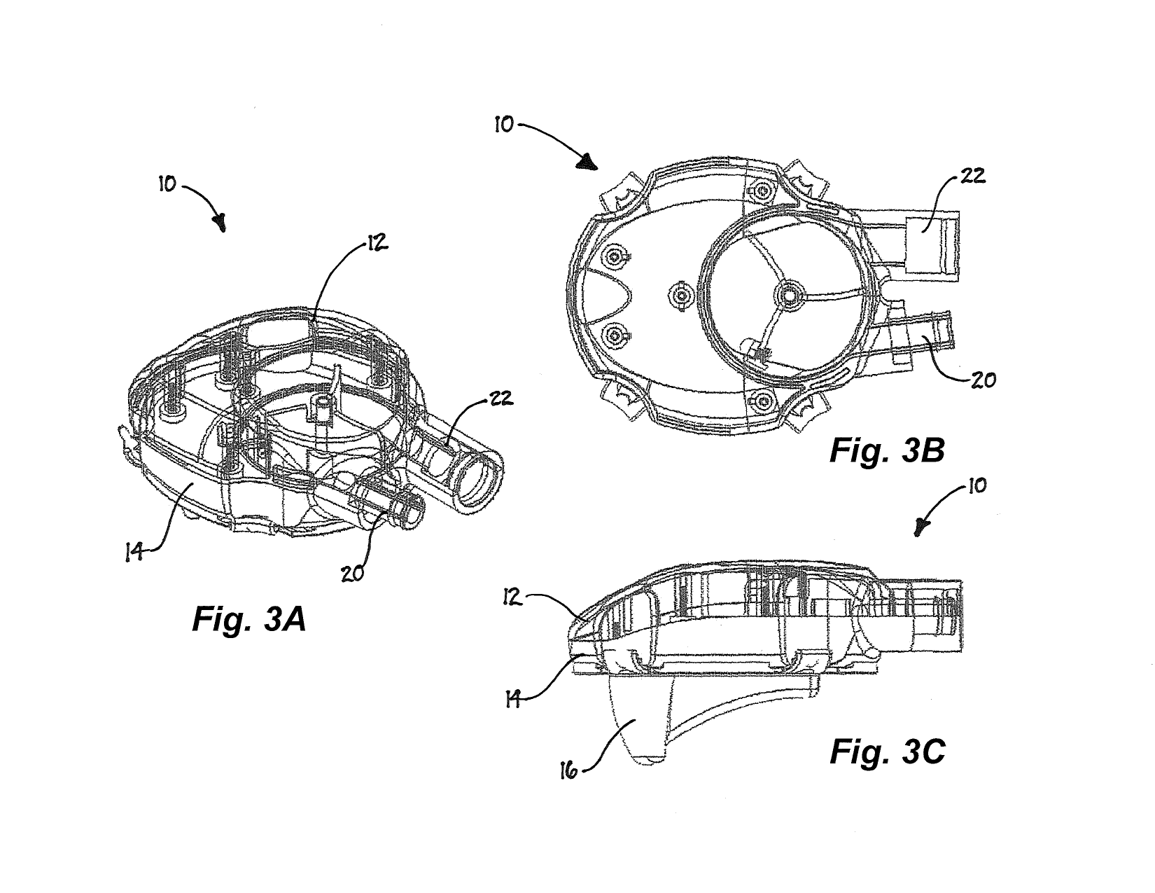

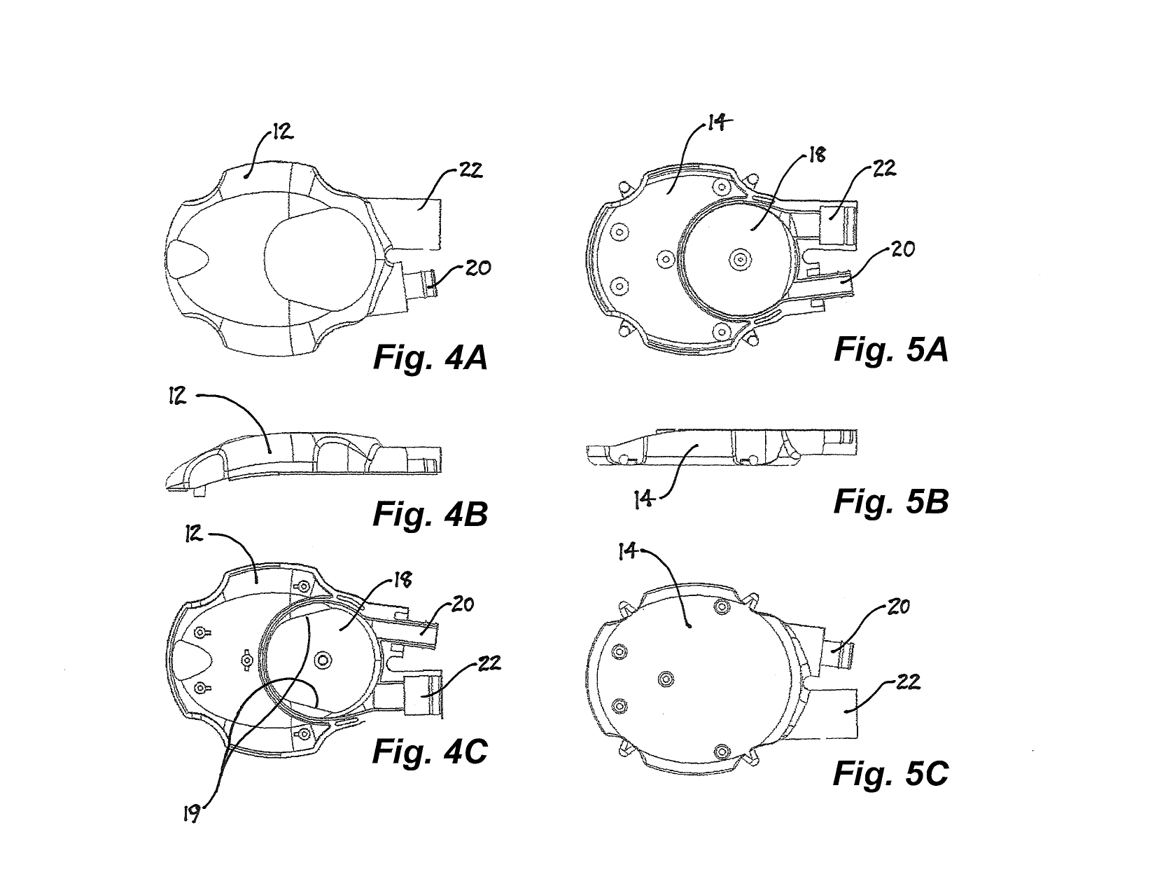

With reference to FIGS. 3A-3C, the massager 10 forms a hand-held unit for massaging application, via the membrane 16, to a user (not shown). As shown, the top shell 12 of FIG. 4A can be arranged and secured to bottom shell 14 of FIG. 5A and similarly for views 4B,5B and 4C,5C. Best seen in the internal views of FIGS. 4C and 5A, one embodiment of the impeller chamber 18 is in the form of a fluted curve profile 19. The fluted profile 19 assists fluid flow entering chamber 18 from inlet 20 to quickly change direction before exiting via the outlet 22. That is, in this embodiment, the chamber 18 expands and angles outwards near outlet 22 to provide an optimal flow path for the fluid to exit via outlet 22 minimizing cavitation and turbulence which otherwise could somewhat impede rotation of impeller 24.

In an embodiment, outlet 22 is larger than inlet 20 in order to minimize resistance to fluid discharge, allowing the fluid entering the chamber 18 to exit quickly and with maximum transfer of fluid energy to the impeller 24. The fluid is normally a mixture of water and air, and therefore allowing this mixture to exit the chamber quickly allows the impellor to spin with minimal resistive counterforce from fluid trapped within the impellor chamber 18. Applicant noted that, in earlier design iterations, where the inlet and outlet were of the same size, fluid tended to enter the chamber 18 and circulate less effectively before exiting the chamber, dampening the effect of massaging oscillation, as well as creating some undesirable cavitation and turbulence. By enlarging the outlet 22, the outlet was sized for greater discharge capacity that the chamber inlet, Applicant notes a greater amount of air and water could exit than could enter the chamber.

In another embodiment, impeller oscillation can be adjusted by adjusting the diameter of outlet 22, or by providing a valve to control the size of either the inlet 20 or the outlet 22 for controlling the flow of fluid through the impellor chamber 18.

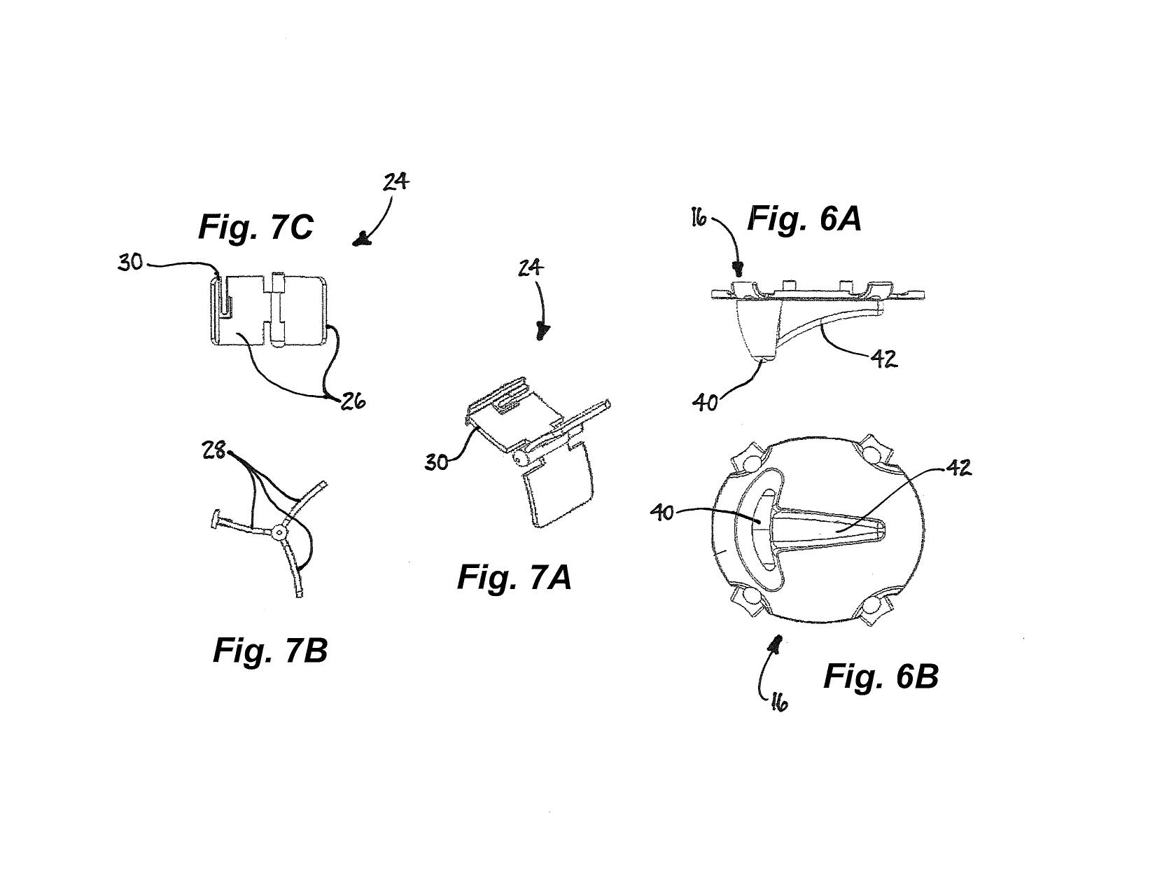

With reference to FIGS. 6A and 6B, showing the membrane 16 in isolation and to FIGS. 2 and 3C shown in context on the massager 10, an embodiment of the membrane 16 is provided for removable attachment to the bottom shell 14 of the massager 10. As shown, membrane 16 may include features for contact with different parts of the user's body to provide a massage. And with reference to FIG. 6A, for example, membrane 16 includes both a concave curved surface 40, and a convex curved surface 42 for massaging different parts of the body.

In an embodiment, membrane 16 may be adapted to receive various attachments on its surface in order to provide different massage sensations. For example, one or more gel pads may be affixed to increase frictional resistance when massager 10 is held against the skin of a user, thereby allowing the user to experience more of the oscillating motion of the massager 10. The use of other types of wraps on the membrane 16 or membranes of different shapes, sizes, shapes and materials also allows the user to adjust the vibratory and oscillatory effects of the massager 10 to larger or smaller afflicted areas, as the user's preference may be, and to increase or decrease the vibratory effect and penetrative potential of the vibrations and oscillations. The use of different styles and textures of wraps also allows delivery of a range of effects from the vibrations of the unit.

With reference to FIGS. 7A through 7C and with reference to back to 2, one form of impeller 24 comprises three radial blades 26 that can be circumferentially spaced at 120 degrees apart. In an embodiment, at least one of the blades 26 includes a weight 30 positioned near the end of the blade 26 resulting in an off-center, imbalanced impeller 24. The off-center weight 30 is selected to provide a desired intensity and range of oscillating motions for the massager 10, given the amount of fluid expected to pass through the impeller chamber 18. The resulting oscillating motion provides a low intensity, kneading motion, manifest at the membrane 16, which is conducive to a potentially deeper tissue massage than percussive motions of a conventional hydro massage merely utilizing a jet of water directed over the skin of a user.

In another embodiment, weight 30 is adjustably positionable radially along a length of the impeller blade 26, allowing the degree of centrifugal force of the weight 30 on the rotation of the impeller 24 to be adjusted. Positioning of the weight 30 closer to the center of the impeller 24 reduces the oscillating motion of the massage unit.

In another embodiment, a heavier weight 30 can be selected to provide a stronger oscillating motion, compared to lighter weights at the same radial location, provided that the weight 30 is within the limits of design constraints given the structural strength of the massager 10.

Therefore, and with reference to a first embodiment of FIG. 8A, and having reviewed the individual components of the massager 10, a massager assembly 2 is provided comprising an inlet conduit 50 for conducting fluid F to the inlet 20 of the impeller chamber 18 and discharging the fluid F through outlet 22 to an outlet conduit 52. The inlet conduit 50 connects the massager inlet 20 to the fluid energizing source. The outlet conduit 52 connects the massager outlet 22 for directed discharge as determined by the user or the conduit orientation.

In this first embodiment of a jet adapter 8, a first adapter 8a is in the form of an intake funnel 60. As shown in FIG. 8B, the intake funnel 60 is shown adaptable to be securely attached to a wall 64 of the water containment vessel of jetted spas, baths and hot tubs, located about a fluid outlet or jet 66 in the wall 64. In operation, intake funnel 60 receives an energizing jet of fluid F from the jet 66. The jet of fluid is then directed through the inlet conduit 50 and into impeller chamber 18 to energize the massager 10. Within impeller chamber 18, the fluid contacts the impeller blades 26 causing the impeller 24 to rotate. The fluid quickly exits chamber 18 via the outlet conduit 52. A hose clip 53 is provided to organize the inlet and outlet conduits 50,52, retaining them together. The inlet and outlet conduits 50,52 can be as long as necessary and flexible so to maximize access and versatility in positioning of he attached massager 10. The inlet and outlet conduits 50,52 can be flexible for ease of manipulation of the massager relative to the jet. Further, the outlet conduit 52 can be manipulated to be positionable beneath the waterline W (See FIG. 1A)

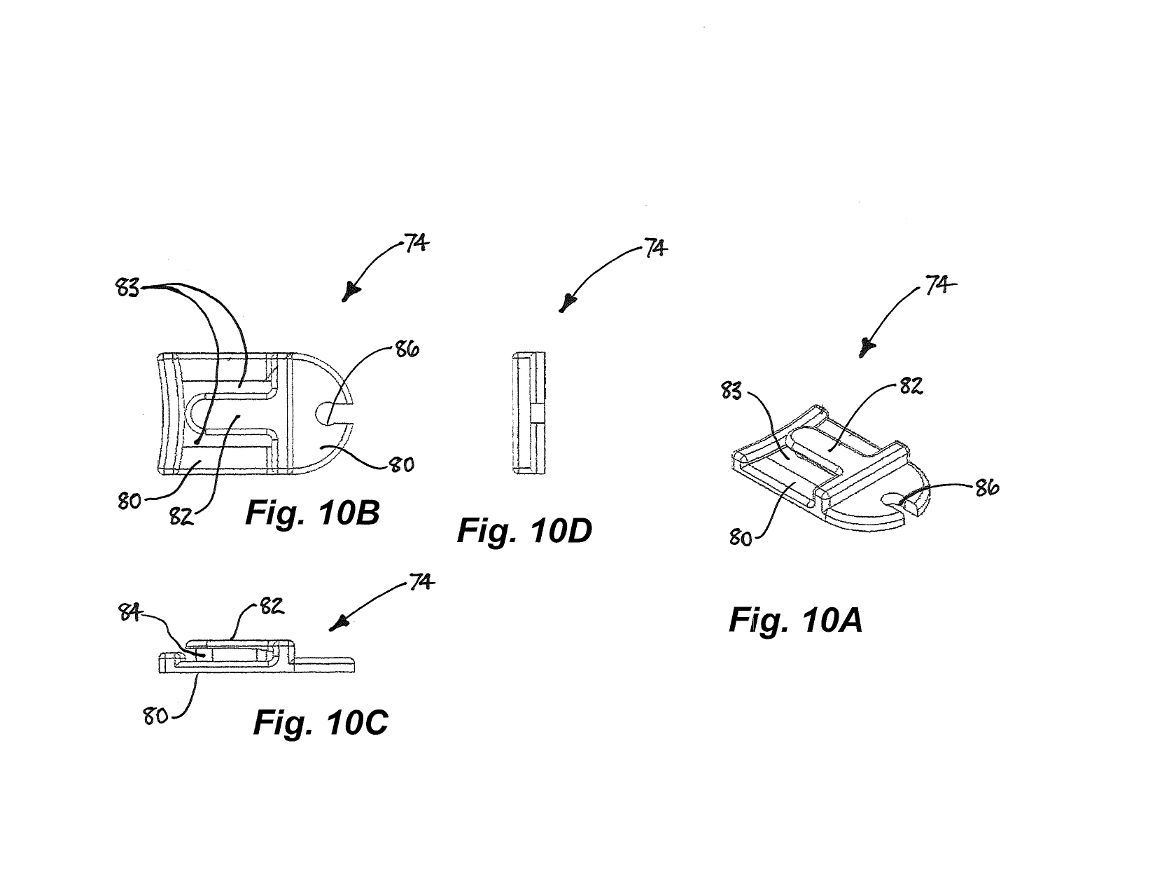

With further reference to FIGS. 9A through 10D, the fluid intake funnel 60 comprises a conical funnel 70 having a wide inlet or funnel base flange 76 narrowing to an apex outlet 72 for fluid connection or coupling to the inlet conduit 50. The base flange includes a plurality of clips 74 distributed thereabout. The clips 74 can be removably attached to the base flange 76. The clips 74 retain or secure a series of attachment means such as suction cups 78 for adhering or gripping the wall 64 and holding the conical funnel 70 in place about the jet 66.

A plurality of slots 79,79 . . . are provided at the enlarged funnel base flange 76, each slot capable of receiving a clip 74. In one embodiment, the suction cups 78 are supported by the clips 74. Alternatively, the same or similar suction cups 78d can be affixed directly to the base flange 76 such as at each slot 79.

Turning to FIGS. 10A-10D, an embodiment of a clip 74 comprises a plate 80 and a cantilevered, resilient tab 82 spaced from and extending over a corresponding opening 83 in the plate 80 and having a having a ridge 84 at a distal end of the tab 82. The ridge 84 normally encroaches into the opening 83. In an embodiment the tab 82, and perhaps the entirely of the clip 74, is flexibly resilient to allow the tab to flex, enabling the ridge 84 to temporarily flex sufficiently away from plate while moving over the base flange 76. The ridge 84 engages slot 79, securing the clip to the base flange 76. The tab 82 is sufficiently resilient to enable installation to the conical funnel 70 but also sufficiently strong to be able to keep intake funnel 60 attached to the clips, suction cups 78 and wall 64 in use.

Clip 74 further includes a notch 86 into which a post (not shown) of a suction cup 78 can be inserted. As many clips 74, as there are slots 79 in base flange 76 may be attached in order to use a plurality of clips 74 and suction cups 78 or suction cups 78d to securely attach intake funnel 60 to the wall 64.

Thus, the design of intake funnel 60 allows it to be adaptably mounted over a wide range of jet sizes, surfaces and positions without the need for mechanical revisions or modifications to existing jet units as installed by the manufacturer.

Use of intake funnel 60, with a sufficient length of inlet conduit 50 connecting the massager 10, allows a user to place and use the massager in a range of seated or reclined positions to reach afflicted areas that are not otherwise able to benefit from the vessel's fixed jets. The option of using or easily switching to a different jet within the tub also allows for flexibility in using and managing the various fluid energy flow rates corresponding to various jets to manage the massaging unit vibratory responses.

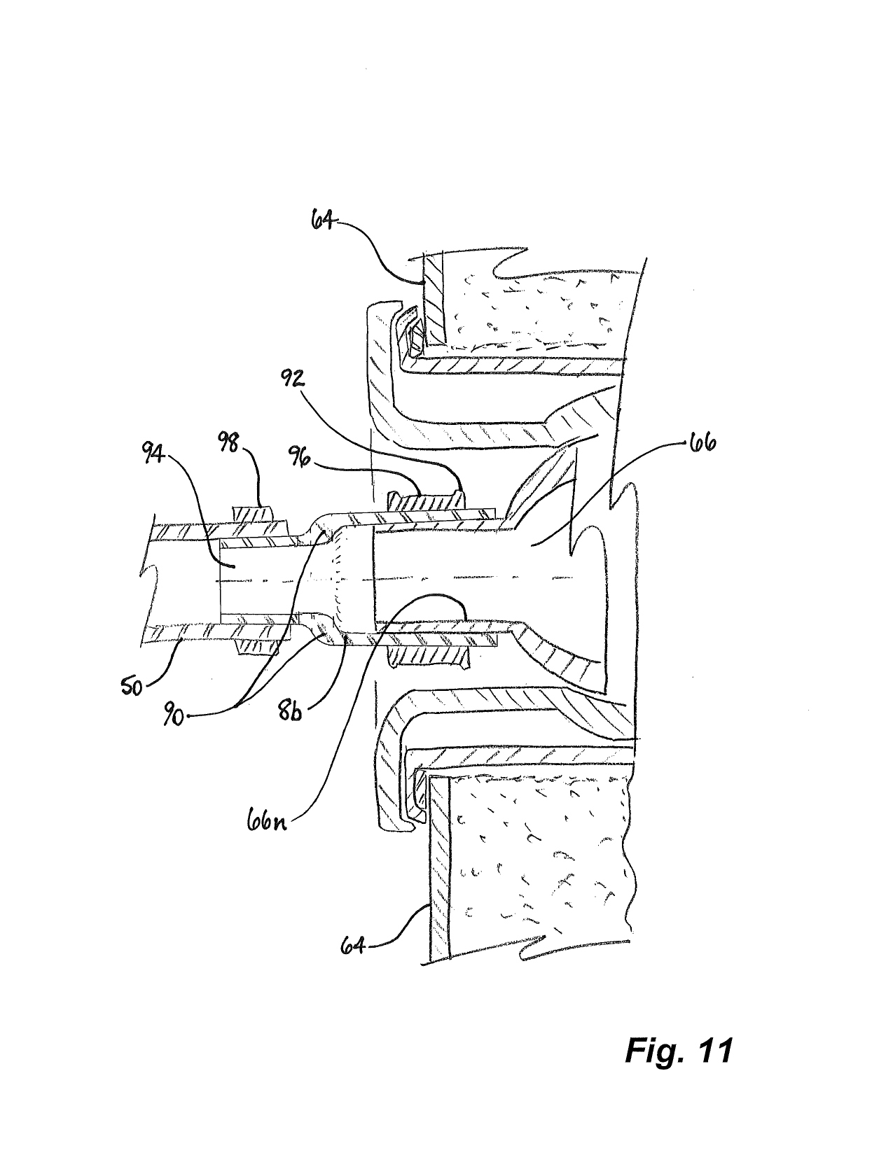

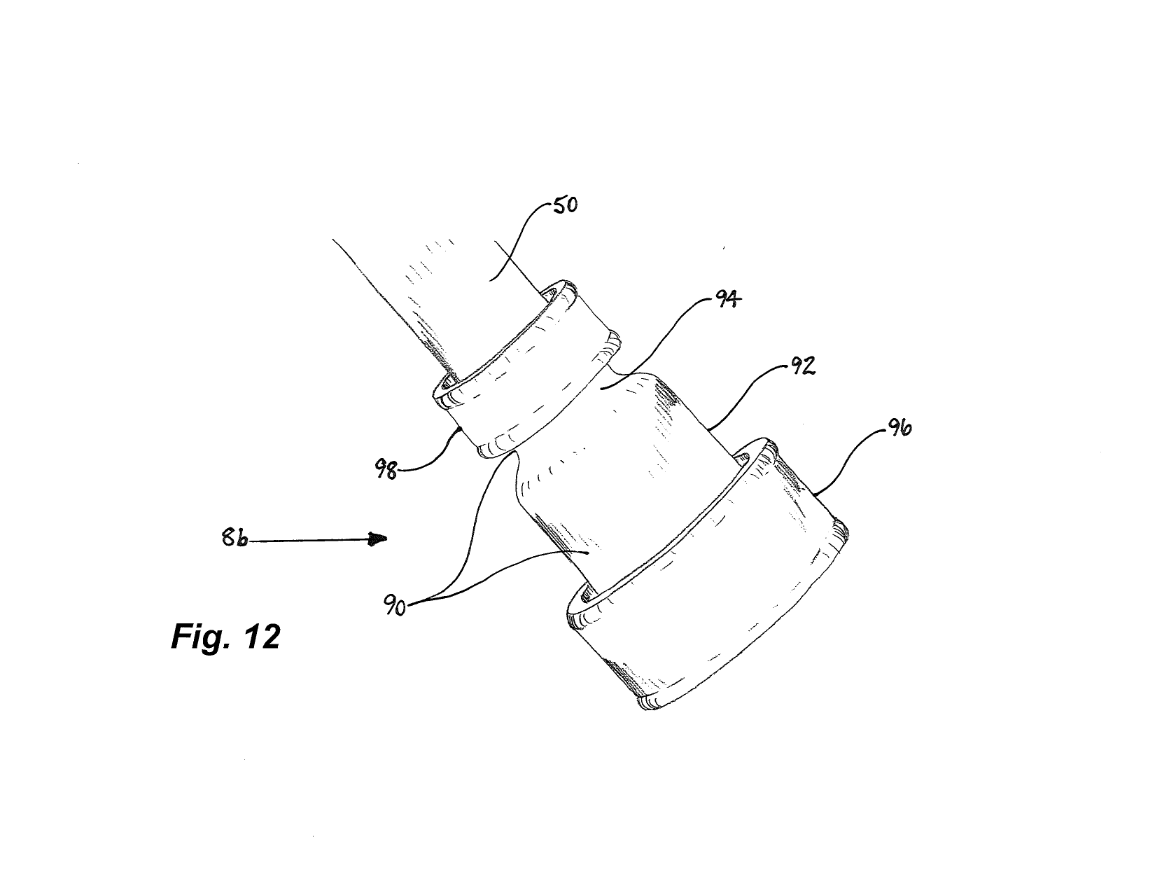

With reference to FIGS. 11 and 12 a second embodiment of an adapter 8 is shown, namely a union adapter 8b for directly coupling an individual jet 66 to the inlet conduit 50. Returning to FIGS. 1A and 1B, one can view the union adapter 8b in the entire context of the massager assembly 2.

Specifically with reference to FIG. 11, the union adapter 8b has a tubular body 90 having a jet end 92 and a conduit end 94. Depending on the size of fluid outlet of jet 66 and the size of the inlet conduit 50, the tubular body 90 could have stepped diameters between jet end 92 and a conduit end 94. In this embodiment, the jet end 92 is sized to fit about, over or otherwise couple to a jet nozzle 66n of a jet 66. The conduit end 94 is similarly sized to fit about, over or otherwise couple to the inlet conduit 50. A variety of conduit-to-conduit end connections are possible including hose clamps and the like. The conduit interface can include barbed interface (not shown) to minimize accidental release.

In the embodiment shown, the union adapter 8b is a short section of resilient tubular conduit. The jet end 92 of the union adapter 8b is sized to slide axially over a jet nozzle 66n accessible from the vessel wall 64. Being resilient, in an embodiment, the jet end 92 can be undersized to flex over the nozzle 66n and be retained thereon by the elastic compression of the jet end over the nozzle. Whether or not the jet end 92 is stretched over the jet nozzle, the adapter 8b can further comprise an annular compression ring 96 which is sized to annularly compress the jet end about the nozzle 66n. The jet end 92 can be slid axially over the nozzle 66n and the ring 96 can be slid onto and over the jet end to axially engage and radially compress the jet end 92 onto the nozzle 66n, retaining the adapter 8b thereon. The tubular body can be manufactured of a resilient plastic such as a polyurethane elastomer. A suitable elastomer is a thermoplastic elastomer or polyether available as Texin® 985 from Bayer Materialscience LLC.

The jet end 92 can be sized for the typical size of nozzle 66n provided by manufacturers. There are only a few manufacturers supplying jets to most spa and hot tub manufacturers and sizing is substantially consistent. While one size of adapter 8b fits the majority of jet nozzles, and a resilient tubular would elastically fit a range of nozzle diameters, one could also provide two or more sizes of adapters 8b, having different sizes and diameters of jet ends 8b. A typical jet is a uni-directional eyeball jet nozzle. For manufacturing efficiency, the massager's inlet conduit and the conduit end 94 would have a consistent diameter, regardless of the size of the jet end 92.

As shown in FIG. 12, the union adapter 8b can comprise a stepped tubular body 90 having a larger jet end 92 and narrower conduit end 94. Two corresponding sizes of annular compression rings are provided, a larger ring 96 for the jet end 92 and a smaller ring 98 for compressing the conduit end onto the inlet conduit 50.

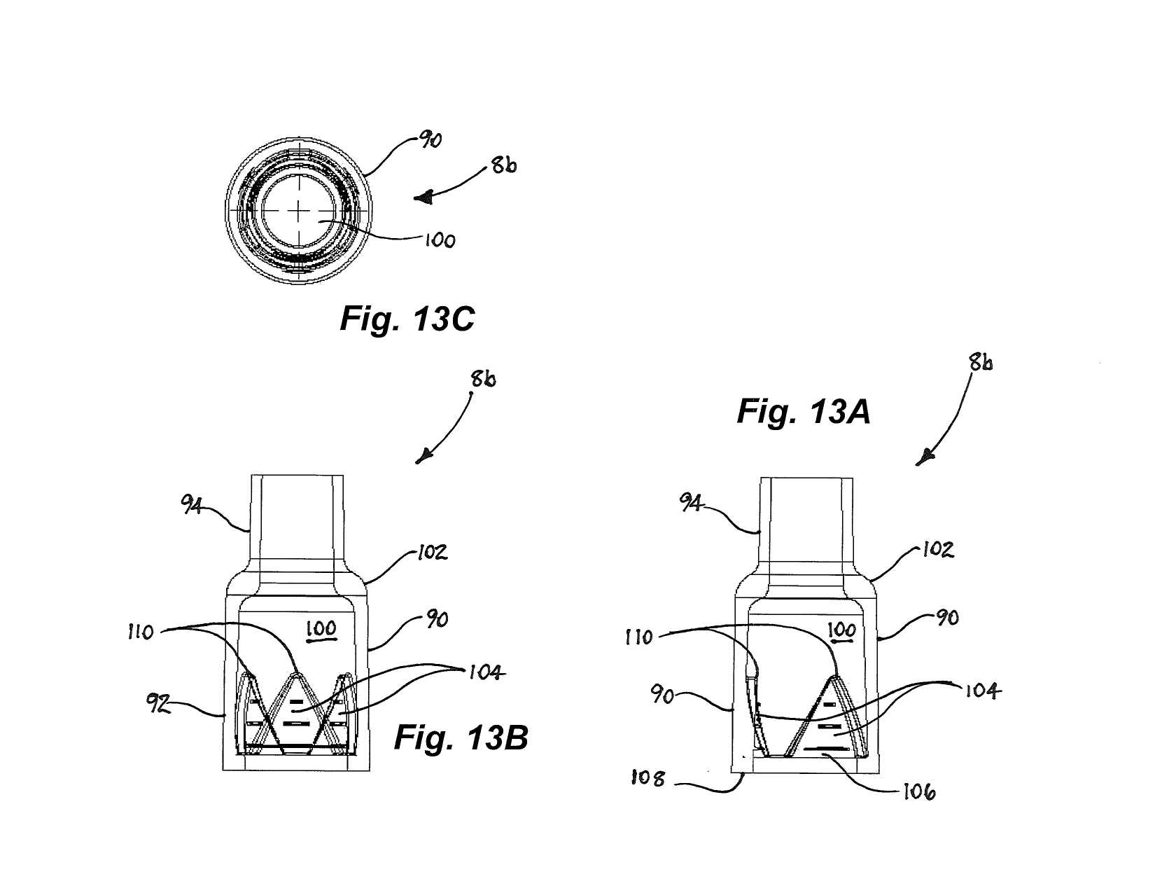

In more detail, and as shown in FIGS. 13A-13C, the union adapter 8b has tubular body 90, the body forming a bore 100 for the passage of fluid. In this embodiment, the jet end 92 is larger in diameter than the conduit end 94, forming a stepped transition shoulder 102. The bore 100 at the jet end can be uniform, as shown in FIG. 11, or include internal profiles of lugs 104 as shown in FIGS. 13A and 13B. Lugs 104 can provide enhance gripping of the jet nozzle 66n. As shown, the lugs 104 are radially inwardly projecting lugs, also formed of the resilient material, for interfacing with the nozzle. Each lug 104 can have a triangular profile having a base 106 at the jet end inlet 108 and an apex 110 within the jet end 92. As shown in FIG. 15A some jets have a lip 112 formed at a distal end of the nozzle 66n. The axial extent of the apex 110 of the lugs 104 can be pre-determined limited so as to axially engage the lip 112.

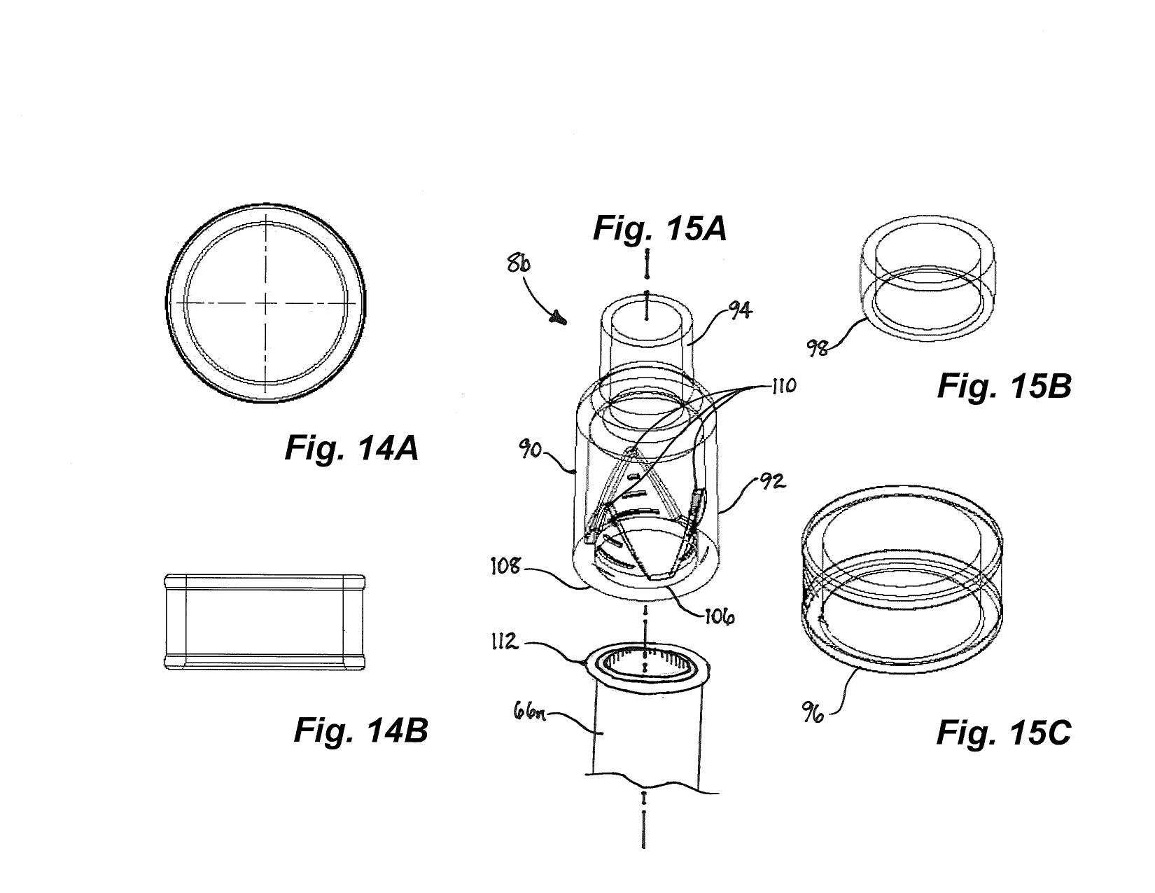

FIGS. 14A and 14B illustrate the generic form of annular compression ring, including the larger, nozzle compression ring 96 and a conduit compression ring 98 as necessary.

As shown in FIGS. 15B and 15C, two sized compression rings are illustrated adjacent the respective jet end 92 and conduit end 94 of the union adapter of FIG. 15A.

A typical jet 66 has a nozzle diameter of about 28 mm. The bore of the jet end 92 has a nominal inside diameter of about 30 mm, an outside diameter of 35 mm, and a restricted effective diameter inside the lugs of 25 mm. The union adapter has jet end length, for receiving the jet nozzle, of about 40 mm. Installed over the jet nozzle, the outside diameter of the jet end expands from 35 to over 38 mm. An annular compression ring, having an inside diameter of about 38 mm compresses the jet end 92 onto the jet nozzle, retaining the union adapter 8b thereon.

Having reference to FIGS. 8B and 1B, in preparation for operation, one fluidly connects the adapter 8, be it the funnel adapter 8a or the union adapter 8b to the fluid source. For a funnel adapter 8a, the conical funnel 70 is attached to the vessel wall 64 such as by suction cups 78, the funnel positioned over the jet 66 for receiving fluid F. For a union adapter 8b, the jet end 92 is slid over the jet nozzle 66n and a nozzle compression ring 96 slid over both jet end 92 and nozzle 62 to retain the union adapter to the jet 66 and receive fluid F.

Once the fluid source is actuated to discharge fluid from the jet 66, fluid flows through the adapter 8,8a,8b, along the inlet conduit 50, flows through the impeller chamber 18 to actuate the massager 10, and exits via outlet 52. The outlet conduit 52 is directed to a discharge point beneath the waterline W (see FIG. 1A), thus eliminating unnecessary and unwanted splashing.

Thus, as described above, a massager and an assembly is provided for use in water vessels and environments including jetted spas, baths and hot tubs, comprising: a hand-held massage unit of massager having an impellor chamber, the impellor chamber including an inlet and an outlet; a first inlet conduit connected to the impeller inlet at a first end and to an adapter at a second end to receive fluid from a jet; and a second outlet conduit tube connected to the impeller outlet at a first end, the second tube of sufficient length to return the jet of water to the vessel beneath a waterline.

In an embodiment, the adapter comprises an intake funnel adapter or union adapter for fluidly connecting the inlet conduit to a jet, the adapter receiving and directing the fluid flow into the inlet conduit. The funnel adapter is a universal adapter for interfacing to a wall of the vessel about a jet and the union adapter is a universal adapter for interfacing to jet nozzles, such as the commonly used uni-directional eyeball jets. The ubiquitous eyeball jets have a consistent diameter and configuration for dependable interfacing. The funnel adapter can be subject to complications in fitting and operation including rough wall surfaces interfering with adherence by suction cups, insufficient planer area about the jet, and leakage about the funnel base flange-to-wall interface. Alternatively, or where the funnel adapter cannot be fit, the union adapter is suitable to secure to a jet, typically at least one jet of a jetted vessel being compatible with the adapter, having a single tubular, or effectively single tubular jet nozzle for engaging the bore of the adapter. The direct union adapter interface further minimized or avoids fluid loss at the point of connection. A specific union adapter may not be amenable to all jet nozzles, requiring a different diameter or depth of bore.

The scope of the claims should not be limited by the preferred embodiments set forth in the examples, but should be given the broadest interpretation consistent with the description as a whole.

The embodiments of the invention for which an exclusive property or privilege is claimed are defined as follows:

1. A massage apparatus for use in a water containment vessel having at least one jet for discharging fluid of water or a mixture of water and air, the vessel having water contained therein for forming a waterline, comprising:
a massager having an impeller chamber, the impeller chamber housing a rotatable impeller having an off-center weight;
an inlet conduit fluidly connected between one jet of the at least one jet and an inlet to the impeller chamber for directing fluid into the impeller chamber and energizing the impeller; and
an outlet conduit fluidly connected to an outlet of the impeller chamber for directing fluid from the impeller chamber for discharge beneath the waterline.

2. The massage apparatus of claim 1, further comprising an adapter for fluidly connecting and securing the inlet conduit to the jet.

3. The massage apparatus of claim 2, wherein the adapter is a union adapter removably secured to a jet nozzle of the jet for receiving the fluid flow therefrom.

4. The massage apparatus of claim 3, wherein the union comprises:
a tubular body having a jet end and a conduit end,
the jet end sized to couple to the jet nozzle, and
the conduit end sized to couple to the inlet conduit.

5. The massage apparatus of claim 4, wherein the jet end of the tubular body fits about the jet nozzle.

6. The massage apparatus of claim 4, wherein the tubular body is resilient.

7. The massage apparatus of claim 6, further comprising an annular compression ring for radial compression of the jet end of the tubular body to the jet nozzle.

8. The massage apparatus of claim 1 wherein the inlet and outlet conduits are flexible for manipulation of the massager relative to the jet.

9. The massage apparatus of claim 2, wherein:
the jet is fit in a wall of the vessel; and
the adapter is a funnel adapter removably secured to the wall about the jet for receiving the fluid flow from the jet.

10. The massage apparatus of claim 9, wherein the funnel adapter comprises:
a base for interfacing with the wall, and
an apex outlet for coupling with the inlet conduit.

11. The massage apparatus of claim 10, wherein the funnel adapter is a conical funnel.

12. The massage apparatus of claim 10, wherein the funnel adapter further comprises a plurality of suction cups distributed about the base for adhering the funnel adapter to the wall.

13. The massage apparatus of claim 10, wherein the funnel adapter further comprises:
a plurality of suction cups for securing to the wall, and
a plurality of clips distributed about the base for securing the suction cups to the base.

14. A method for operating a massager in a water containment vessel having at least one jet, the method comprising:
providing a fluid-operated massager
fluidly connecting an inlet of the massager to one jet of the at least one jet for energizing the massager; and
directing fluid from the massager for discharge beneath a waterline of the vessel.

15. The method of claim 14 wherein the fluidly connecting the massager to the one jet further comprises:
connecting one end of an inlet conduit to the massager inlet and an opposing end to a jet adapter; and
securing the jet adapter to the one jet for receiving the fluid therefrom.

16. The method of claim 15 wherein the securing the jet adapter further comprises securing a funnel about the jet for directing the fluid into the inlet conduit.

17. The method of claim 16 wherein the securing of the funnel about the one jet further comprises providing a plurality of suction cups about a base of the funnel and adhering the suction cups to a vessel wall about the one jet.

18. The method of claim 15 wherein the securing the jet adapter further comprises securing a tubular union adapter to a jet nozzle of the one jet for directing the fluid through a bore of the union adapter and into the inlet conduit.

19. The method of claim 18 wherein the securing of the union adapter to the jet nozzle further comprises sliding a jet end of the union adapter over the jet nozzle and compressing the jet end over the jet nozzle for securing the union adapter thereto.
